(19) United States
(12) Patent Application Publication
(10) Pub. No.: US 2015/0127483 A1
(43) Pub. Date: May 7, 2015

(54) SYSTEMS AND METHODS FOR OPTIMIZING AND STREAMLINING THE SHOPPING EXPERIENCE IN A RETAIL ENVIRONMENT

(71) Applicants: Jacob Elliot, Woodury, NY (US); Nicholas Sando, Strafford, VT (US); Andrew Rodriguez, Hialeah, FL (US); Michael Rodriguez, Hialeah, NY (US); Eduardo Deleon, Hialeah, FL (US)

(72) Inventors: Jacob Elliot, Woodury, NY (US); Nicholas Sando, Strafford, VT (US); Andrew Rodriguez, Hialeah, FL (US); Michael Rodriguez, Hialeah, NY (US); Eduardo Deleon, Hialeah, FL (US)

(21) Appl. No.: 14/507,756

(22) Filed: Oct. 6, 2014

Related U.S. Application Data
(60) Provisional application No. 61/887,397, filed on Oct. 6, 2013.

(51) Int. Cl. G06Q 30/06; G06K 7/10

(52) U.S. Cl. CPC G06Q 30/0633; G06K 7/10366
USPC 705/26.8

(57) ABSTRACT

Methods and systems for improving retail shopping experiences of users and providing users with product suggestions based on merchandise items in which the user has displayed an interest. User interest may be determined based both on merchandise items selected in a retail environment and merchandise items the user already owns. Methods for soliciting user feedback as well as providing an interface for soliciting feedback from social networks are incorporated in the systems and methods.

### STATEMENT REGARDING FEDERALLY SPONSORED RESEARCH

N/A

### FIELD OF THE INVENTION

The present invention relates to the use of mobile electronic devices and e-commerce activities. More particularly, some embodiments of the present invention relate to the use of mobile electronic devices in a retail environment to streamline and optimize retail shopping.

### BACKGROUND OF THE INVENTION

When customers enter a retail environment to shop for a product, they must make decisions based either on information known to them before entering the retail location or from a limited amount of information presented at the location. Generally, if a customer is interested in a particular item, the amount of information upon which the customer can make a decision is limited. Various internet sites and software applications exist to provide consumers with information on products and services, including shopping comparison sites and mobile applications (“apps”) that provide reviews, prices, and other useful information relevant to a given product. These sites and apps, however, are manually and individually accessed by the customer, and generally do not provide focused information relevant to a customer's purchase decision of a certain product when the consumer is in a retail environment.

### SUMMARY OF THE INVENTION

As specified in the Background Section, above, there is a great need in the art to develop new tools for simplifying and streamlining the shopping experience. To address these and other needs, the following is disclosed.

An embodiment is a near field communication (NFC) application that allows customers to gain access to information about items offered for sale in retail locations by selecting or “snagging” the item by tapping the item of interest with a mobile NFC enabled mobile device. The tapping action causes an NFC chip on the item to communicate with a user's NFC enable mobile device. When the user selects an item, a cloud-based account is set up for the user by the system. As a user selects (“snags”) various items, information is received by the application server, and stored in a database, thereby keeping track of selections (“snags”.) The information collected may include the user's unique IP address, the time and date of the selection (“snag”), location in the retail location where the snag occurred and the like. social media information associated with that user and the like. When a customer snags an item tagged with an NFC tag by tapping the tag with his or her smart phone, the application will automatically launch and place all of the information about the product on a clearly viewable screen, as well as putting data about the selected item on a virtual shopping cart for the customer.

An embodiment is a method for optimizing and improving a user's retail shopping experience comprising: entering merchandise item data into a merchandise database, assigning an NFC ID to each merchandise item, entering merchandise related information associated with each merchandise item, applying NFC tags to merchandise items to be displayed in a retail location, allowing users to select (“snag”) at least one merchandise item that is displayed in a retail location, providing a checkout service to allow the user to purchase the at least one snagged merchandise item. In embodiments the method further comprises pushing merchandise related information to users. In embodiments the method further comprises soliciting user feedback about selected and related merchandise items and using user feedback to customize product recommendations to the user. In embodiments the method further comprises curating a wish list of merchandise the user desires to purchase at a later time.

An embodiment is a method for providing customized product recommendations to at least one user comprising: prompting a user to create an account with a NFC enabled retail shopping system, allowing the user to visit at least one retail shopping location, allowing the user to select (“snag”) at least one item of merchandise, saving the selected merchandise item(s) to snag history, accessing merchandise related information from a database related to the merchandise item(s) selected by the user, providing the user with product suggestions based off the related merchandise information related to the merchandise item (s) selected by the user, allowing the user to select additional merchandise items selected from the product suggestions provided by the system, and providing a checkout interface to allow the user to purchase selected items. In embodiments the method further comprises prompting the user to input the merchandise the user already owns into an owned merchandise database (“closet”). In embodiments the method further comprises providing product suggestions based on items the user already owns. In embodiments the method further comprises adding items purchased through the system to the user's owned merchandise database (“closet”). In embodiments, the recommendations are provided to the user by sending push notifications to the user.

An embodiment is a method for providing customized product recommendations based on items a user already owns comprising: generating a plurality of merchandise sets (“outfits”) comprising a plurality of individual merchandise items, storing the merchandise sets (“outfits”) in an outfits database, accessing a user's owned merchandise database (“closet”), identifying merchandise items in user's closet, accessing the outfits database, identifying outfits associated with individual merchandise items in the user's closet, suggesting an outfit to the user wherein the outfit contains at least one item of merchandise already owned by the user, and providing access to point of sale and/or suggested retail locations to allow the user to purchase the other merchandise items to complete the outfit.

An embodiment is a system to streamline and optimize user retail shopping experience comprising a plurality of NFC tags each encoded with information about at least one merchandise item, a merchandise related information database containing a variety of information about a plurality of merchandise items, an application which provides users with the ability to select merchandise items by tapping the merchandise item's associated NFC tag with the user's mobile device and provides the user with the ability to purchase the selected merchandise item, and provides the user with product suggestions based on the user's product selections and the merchandise items the user already owns.

### BRIEF DESCRIPTION OF THE DRAWINGS

FIG. 1 shows an overall view of the steps of a method according to an embodiment of the invention.

FIG. 2 shows the steps of a method according to an embodiment of the invention for setting up the system from the point of view of a retailer or merchant.

FIG. 3 shows the steps of a method according to an embodiment of the invention from the point of view of a user.

FIG. 4 shows the steps of a method according to an embodiment of the invention illustrating the outfit-based product recommendation functions.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein the term “merchandise related information” generally refers to data concerning a particular product or group of products. The data may comprise product features, ratings, reviews, price comparisons, social network data, product news, and other similar information that may be useful to customers. In particular the data concerning a particular product or products includes products similar to a given product and/or products that are related to a given product.

An embodiment is method for improving a user's retail shopping experience comprising: selecting a plurality of merchandise items; entering a plurality of merchandise item data into a merchandise database; assigning an NFC ID to each of the plurality of merchandise items; entering a plurality of merchandise related information into the merchandise database wherein the plurality of merchandise related information is associated with the plurality of merchandise items; tagging the plurality of merchandise items with an NFC tag; displaying the plurality of merchandise items in at least one retail location; allowing a plurality of customers to snag at least one of the plurality of merchandise items that are displayed at the at least one retail location; and providing a checkout service to allow the user to purchase the at least one of the plurality of merchandise items that are displayed at the at least one retail location. In some embodiments, the method further comprising sending at least one push notification to the user wherein the push notification contains merchandise related information. In some embodiments, the method further comprising the step of soliciting a user feedback response about at least one merchandise item and using the user feedback response to provide at least 1 product recommendation to the user. In some embodiments, the method further comprising curating a wish list of merchandise items the user wishes to purchase at a later time. In some embodiments, the method further comprising posting an image of a snagged merchandise item to the user's account on a social network website and soliciting members of the user's social network to provide feedback on the snagged merchandise item. In some embodiments, the method further comprising providing the retail location data about customer snags.

Another embodiment is method for providing customized product recommendations to a user comprising: prompting a user to create an account with an NFC enabled retail shopping system; allowing the user to visit a retail location, wherein the retail location has incorporated the NFC enabled retail shopping system; allowing the user to snag an at least one merchandise item; saving the at least one merchandise item snagged by the user to a snag history; accessing a database containing a plurality of merchandise related information related to the at least one merchandise item snagged by the user; providing the user with at least 1 product suggestion based off the plurality of merchandise related information related to the at least one merchandise item snagged by the user; allowing the user to select the at least one product of the at least 1 product suggestion based off the plurality of merchandise related information related to the at least one merchandise item snagged by the user; and providing a checkout interface to allow the user to purchase the at least one merchandise item snagged by the user, and/or the at least one selected product of the at least 1 product suggestion based off the plurality of merchandise related information related to the at least one merchandise item snagged by the user. In some embodiments, the least one product suggestion is sent to the user via a push notification. In some embodiments, the method further comprising adding merchandise items purchased through the checkout interface into an owned merchandise database. In some embodiments, the method further comprising prompting the user to input at least one merchandise item the user already owns into an owned merchandise database. In some embodiments, the method further comprising providing at least one product recommendation based off a plurality of merchandise related information about the at least one merchandise item the user already owns.

Another embodiment is method for providing customized product recommendations to a user based on merchandise items a user already owns comprising: generating a plurality of merchandise sets, wherein the merchandise sets comprise a plurality of individual merchandise items; storing the plurality of merchandise sets in a merchandise set database; accessing an owned merchandise database of the user; identifying at least one individual merchandise item in the user's owned merchandise database; identifying the plurality of merchandise sets that contain the at least one individual merchandise item in the user's owned merchandise database; suggesting the plurality of merchandise sets that contain the at least one individual merchandise item in the user's owned merchandise database; and providing the user with a way to purchase the plurality of merchandise sets that contain the at least one individual merchandise item in the user's owned merchandise database. In some embodiments, the method further comprising identifying individual merchandise items necessary to complete the merchandise set. In some embodiments, the way to purchase the plurality of merchandise sets is a checkout interface. In some embodiments, the way to purchase the plurality of merchandise sets comprises providing the user with a list of retail locations.

In an embodiment the invention is a system for shopping and providing various shopping related services, the system comprising an application running on an NFC (near field communication) enabled computing device such as a smart phone or other mobile device, at least one item of merchandise tagged with an NFC chip/tag, wherein the NFC chip/tag encodes information about the at least one item of merchandise, a merchandise database populated with merchandise related information, a customer selection database operatively coupled to the merchandise database, a retailer portal allowing retailers to access information stored in the customer selection and merchandise databases, and a customer portal allowing customers to access information in the customer selection, and merchandise databases.

The use of the system will provide various benefits to the retailers that employ the system. For example, since the chips are live and editable via a centralized database, the retailer will be able to change labels without having to print new ones. The system will also provide for faster checkout times, thereby reducing the need for on-hand staff. By connecting the application with social media, such as Facebook, retailers will gain superior information about customers and make it easier for the retailers to identify key demographics about their customers and tailor their advertising and production to that demographic. In addition, the use of the system will allow retailers to keep their inventory at a minimum as it is anticipated that many users will choose to ship selected items to their homes instead of carrying the items home from the retail location. An additional benefit of the system is that it creates a “heat map” (graphical representation of the location of the retail location where users have selected merchandise items) to help with merchandising. For example, people are tapping many items in the front of the store but not in the back, this could be a merchandising problem where the retailer would want to move some inventory around to create more sales.

Hardware: All new Android™, Iphone™ and Blackberry™ smartphones are equipped to the ability to recognize and communicate with NFC chips. The chips or tags incorporated into retail items may be any NFC chip known to those skilled in the art or later invented. For example, a substantially rectangular tag of approximately 12 mm×19 mm that is flexible, water proof and can be applied as a sticker, using an adhesive backing layer. Another option would be a 14 mm circular, ultralight laundry tag. Other NFC tags known to those having skill in the art are also compatible with the systems and methods of the invention. In addition to NFC tags, other tagging options that store and transmit data about a merchandise item can be employed, such as, for example BLE (“bluetooth”) enabled tags, bar codes, and/or QR codes. The tags may be associated with merchandise items in any way known to those having skill in the art, such as, for example, embedding into the merchandise item, applying the tag to the merchandise item using adhesive, incorporating the tag into the price-tag of the item, and the like.

Merchandise Database and Customer Selection Database: The databases may be created, collated and maintained with any technology and methods known to those having skill in the art. For example, the databases may be created and stored using the Parse API. Parse is a database back end software system that simplifies the process of storing accessing and utilizing data on the cloud. Parse allows for the creation of user profiles and can link to other APIs such as Facebook™, Google+™ and the like. Another possibility is a Kinvey database to provide back end storage and access. The databases of the system are linked to the application in that the application makes “queries” to a cloud code interface. The cloud code server then processes the request and sends a response in the form of a clothing Object, or a list of clothing objects.

In use, the customer/user downloads the application onto his/her smart phone or other mobile device. The user can then enter a retailer who has enabled the system, by tagging their merchandise with NFC tags. To select an item, the user taps the NFC tagged merchandise with his/her mobile device. The application will then display information about the selected merchandise, such as, for example, a picture of the merchandise, size, color, price, options, reviews, availability, discounts, coupons, related items and the like. The application will provide the customer with various options. For example, the customer may purchase the item using an in-application purchase option and either take the item home from the retail location or have the item delivered. The delivery option may be particularly beneficial in the event that the size, color or other option that the customer desires is not available at the retail location or if the customer does not want to have to carry the item around. Another option available to customers is the “send to fitting room” option. With this option the customer, can indicate which items he or she desire to try on before purchasing. When a user selects this option, a communication will be sent to the retailer and a sales associate or other appropriate agent will bring the selected items to the fitting room so that the customer does not have to carry a variety of items around the store. This will also aid retailers in keeping displays neat and tidy as customers will not have to rifle through merchandise in order to find the correct size(s). Another option users will have is the “Do I Look Good In This Option.” Using this feature, users will have the ability to link to various social media accounts, such as Facebook, Twitter and the like in order to solicit opinions from social connections on whether the selected item would look good on the user.

The users' interactions with merchandise may also be made available to the retailer or stored as part of a general customer information database. By collecting information on what items are selected, and with what frequency, data can be gathered about which items are the most popular or unpopular with consumers. In addition, by correlating items which are selected by the same customers, it will be easier to make product recommendations.

Retailers will be provided with an with an “instore dashboard” that allows them to track the system's analytics and implement the “heat map” feature in order to optimize the placement of their merchandise to maximize sales. Algorithms are in place to track periodicity of “Snags” and provide a “heat” map of the store correlating merchandise items' in-store coordinates to the volume of NFC events on the merchandise item.

Turning now to the figures:

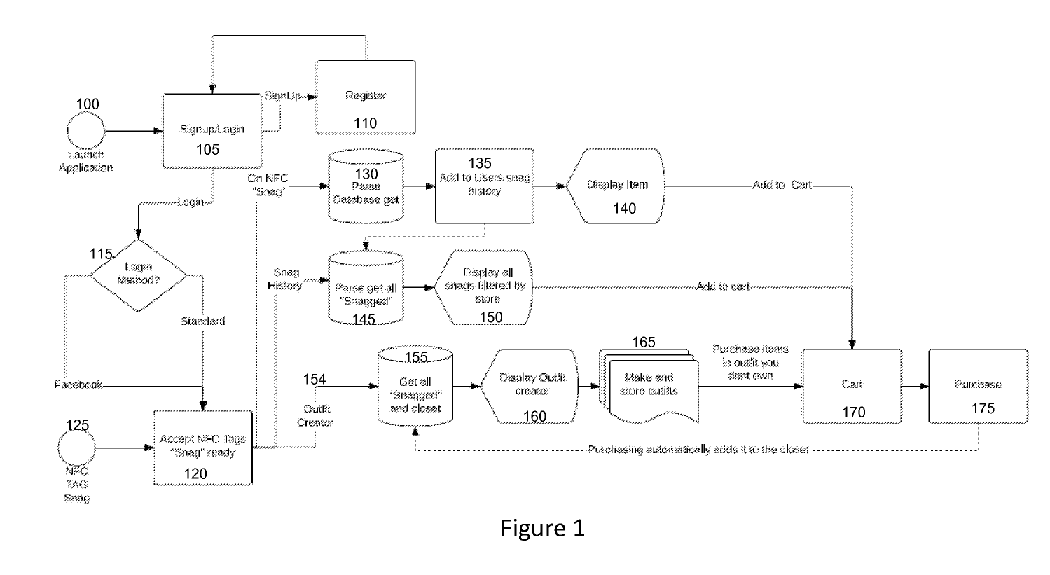

FIG. 1 shows an overall view of the steps of an embodiment of the invention. To begin a user launches (100) the application that he or she has previously downloaded or otherwise obtained on his or her mobile device. The user is then prompted to sign in (105), if the user already has an account, or sign up (105) if the user has not previously created an account. If the user has not previously created an account and wishes to do so, the user will be directed to register (110). Following registration the user will be prompted to log in. Regardless of whether a new registration event takes place or if the user has previously registered, the user will have the option to log in using his or her choice of methods (115): either standard methods such as with a user name and password, or via a social media account such as Facebook. Once logged in the user visits a retail location to select merchandise items of interest. When a user identifies a merchandise item of interest, the user selects or “snags” (125) the merchandise item by placing his or her mobile device in proximity to an NFC tag coupled to the merchandise item of interest. The NFC sensor on the mobile device registers the snag and prompts the user to accept the selection (120). If the user accepts the snag the system initiates a parse database get (130), then adds the selected item of merchandise to the users snag history (135) and displays the item to the user (140). The user is then prompted to add the item to his or her cart (170) at which point the user may purchase the item (175.) Alternatively, on acceptance of the snag (120) the system initiates a parse get all snagged (145). The system then will display all snagged items at that retail location (150). The user will then have the option to select individual or multiple merchandise items to add to his or her cart (170). Alternatively, on acceptance of the snag (120) the system will initiate, either on its own, or at user selection, the outfit creator function (154). Outfit creator functionality is more fully described below, but generally, the system will initiate a get all snagged and closet items (155). The system then displays the outfit creator (160) The outfit creator populates a slide scroll with all clothing “snagged” and in the user's closet categorized by “top”, “bottom”, “shoes” and the like. The outfit creator allows the user to mix and match items purchased already with items the user has snagged whilst browsing at a retail location. The user is then prompted to make and store outfits (165). The system will then compare the individual items in the created outfits to determine which individual merchandise items in each created outfit are not yet owned by the user. The system then displays the items the user does not own and gives the user the option to add those items to his or her cart. Particular emphasis will be placed on items the user does not own that are available at the retail location where the user is currently shopping. The user may then add those items to the cart (170) and continue to purchase (175).

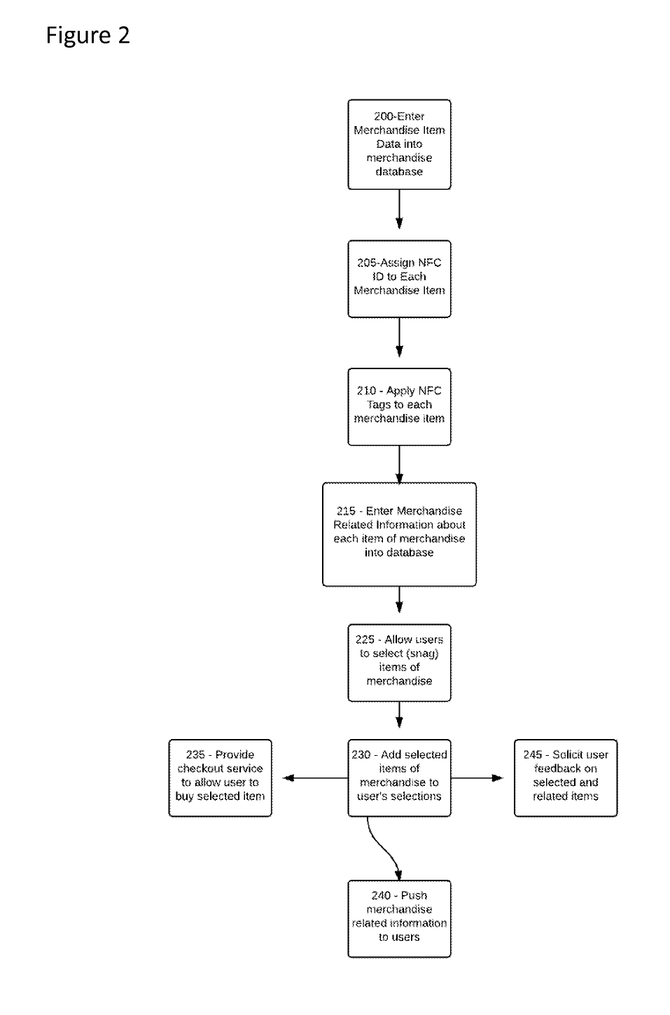

FIG. 2 shows the steps of the method of an embodiment of the invention for setting up the system from the point of view of a retailer or merchant. The merchant enters merchandise item data into a merchandise database (200). Alternatively, a central merchandise database can be maintained by wholesalers or product makers and individual merchants and/or retailers may access that database. As part of entering merchandise data into the merchandise database an NFC ID is assigned to each item of merchandise (205). The NFC ID is associated with an NFC tag. NFC tags are then applied to individual merchandise items associated with that NFC tag and ID (210). Merchants also enter merchandise related information about each item of merchandise into the merchandise database or other database (215). Merchandise related information comprises various information about the product, similar products, complementary products and the like. Once the merchandise database(s) is populated with the individual merchandise item data and the related merchandise data, users will be allowed into the retail location to begin shopping with the system. In use, users will browse the retail environment and select (snag) (225) items of interest using the NFC enabled selection mechanism previously described. Snagged items are added to user's selections which are stored in the system (230). Once the user's selections are stored in the system, the system provides a checkout service to allow the user to purchase the selected item(s) (235). In embodiments the system will also push merchandise related information to users (240) to generate additional sales. In embodiments the system also solicits feedback on selected and related items (245). User feedback on selected and related items is used by the system to personalize and improve recommendations for users.

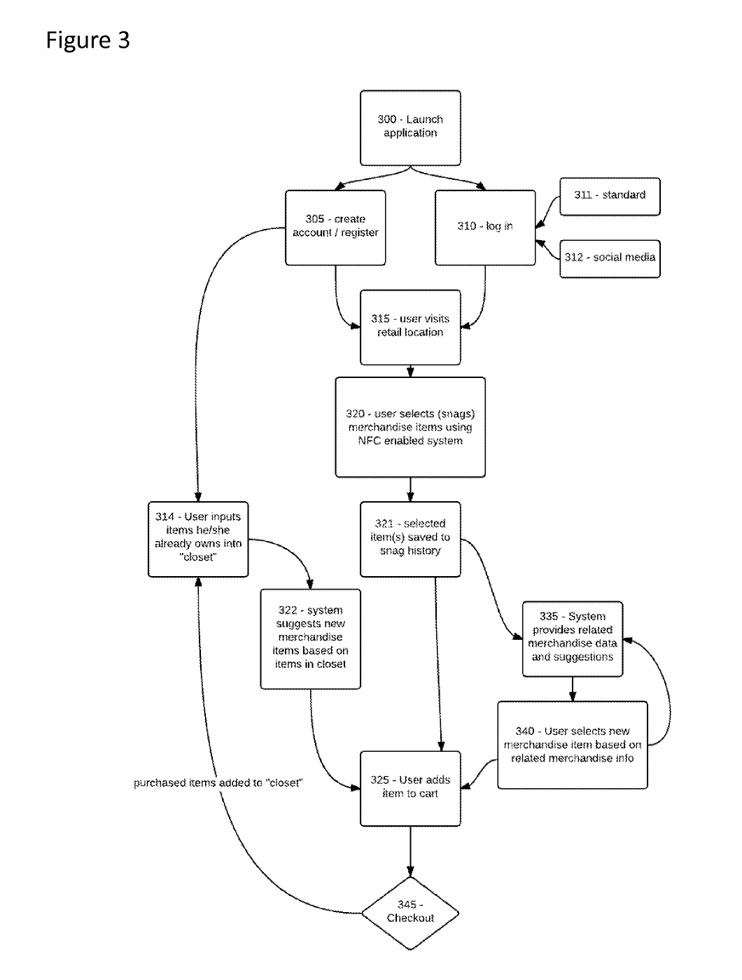

FIG. 3 shows the steps of a method according to an embodiment of the invention from the point of view of a user. The user initiates the process of using the method by launching (300) the application that the user has obtained previously via downloading or otherwise. The user is then prompted either to register (305), if the user has not previously registered or log in (310), if the user has previously registered. Logging in can be accomplished in various ways, such as, for example according to standard methods (311) such as providing a user name and password or logging in through a social media account (312). Once the user has logged into the system, the user then inputs various items he or she owns into the system (314). The items the user already owns are stored in the user's closet (314). The user will be given the ability to add items they already own to their closet by opening the closet page and using the “add to closet” button to then snag or otherwise select an item and add it to their personal closet. Based on the items stored in the user's closet, the system will suggest new merchandise items (322) that may be of interest to the user. In embodiments this is accomplished by accessing a related merchandise database populated with information on products associated with individual merchandise items. By accessing this database, the system will be able to suggest additional merchandise items based on what the user already owns. The user will then have the option to select these additional items and add them to a cart (325) for purchase/checkout (345). Items that the user purchases through the system are automatically added to the user's closet (314). Additionally/alternatively after account creation/registration (305) the user utilizes the system for on-location retail shopping. In embodiments, the user will visit a retail location (315) and select (snag) items of merchandise using the NFC tag enabled selection system described herein (320). The selected items are saved to selection/snag history (321) or otherwise displayed to the user. The user then has the option to add the item to a shopping cart (325) and purchase it via the checkout feature (345). Additionally/alternatively after selected items are saved to snag history, the system will provided related merchandise data and suggestions for additional product selections based on the items the user has selected/snagged (335). In response to the suggested items, the user has the option of selecting new merchandise suggested by the system (340) and proceeding to checkout (345).

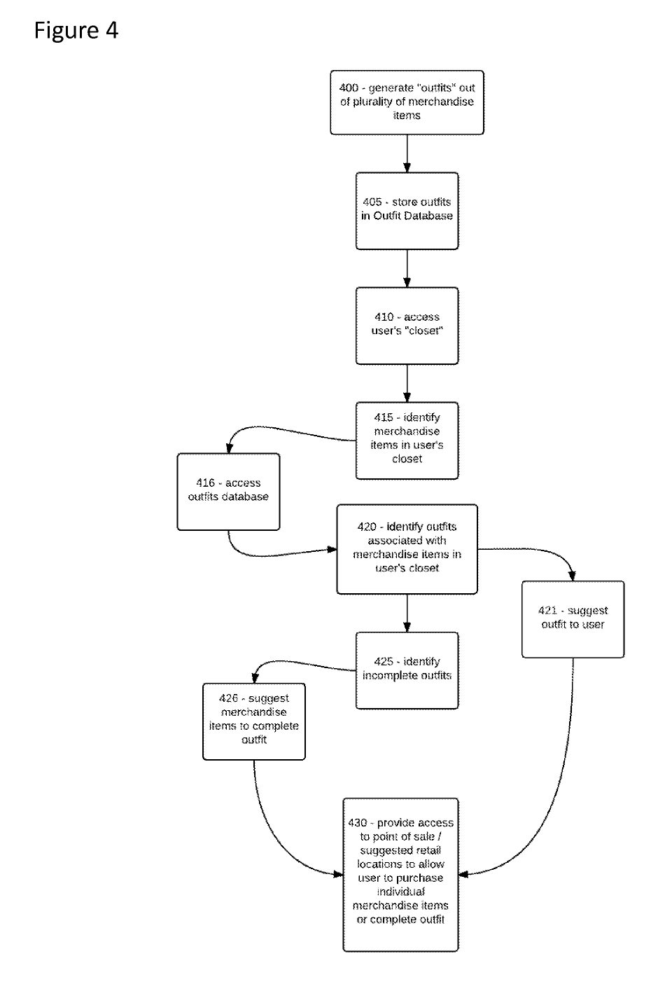

FIG. 4 shows the steps of a method according to an embodiment of the invention illustrating the outfit-based product recommendation functions. A plurality of outfits are generated (400) by putting together a plurality of merchandise items that match, go-together, or otherwise complement each other. The outfits are stored in an outfit database (405). In order to provide suggestions to users, it is useful to compare items users already own against outfits in order to ascertain what items are necessary to complete an outfit. To accomplish this, the system accesses the users closet (410) to identify merchandise items the user already owns (415). The system next accesses the outfits database (416), and identifies outfits associated with merchandise the user already owns (425). The system then can either identify incomplete outfits (425) and/or suggest and outfit to the user (421). In the case where the system identifies incomplete outfits (426) the system will next suggest individual merchandise items needed to complete the outfit and provide access to point of sale locations (430) where the individual merchandise items may be purchased. The point of sale locations may be e-commerce retailers which the user can access via their mobile device for immediate purchase or brick and mortar retail locations where the user can go to buy the items in person. In the case of brick and mortar locations, the system may provide stock information on whether the item(s) are available and in what sizes, and possibly provide coupons or other discounts to incentivize purchase. In the case where an entire outfit is suggested to a user (421), the system will also provide access to point of sale locations (430) where the individual merchandise items may be purchased. The point of sale locations may be e-commerce retailers which the user can access via their mobile device for immediate purchase or brick and mortar retail locations where the user can go to buy the items in person.

### Example 1

Creation of a digital shopping cart in a physical store. As a customer browses in a retail clothing store equipped with the system, the customer may tap as many NFC tagged items as he or she likes. With each tap the app instantly displays to the customer key information about the item such as, size, color, features, washing requirements and recommendations of similar items or items that go with the selected item. The application populates a virtual shopping list as well as a user's history. The user is able to view their previously purchased items from the store in a virtual closet and see if the selected items match the items they currently own. The system of the present invention gives users the option to purchase the item immediately and have it shipped to any desired location. In this way the system combines the benefits of an online approach with the ease and familiarity of an in-store experience. If the item the customer wishes to purchase is out of stock, system may later notify the customer when the item becomes available. With customer details stored in the system's database, the system allows for lower in-store inventory levels.

Customers often encounter the problem of not knowing whether they really like an item and may want an outside opinion from a trusted source, such as a friend. With the fluidity of social networking platforms the Parse database generates, customers can ask a friend through Facebook or other social media network “Would I look good in this?” This movement onto social networking platforms also allows customers to give feedback on selected (snagged) products, which benefits both the retailer and the consumer.

With the NFC chip embedded in the garment, it makes it much easier for returns or exchanges to be made using the digital receipt generated from the purchases within the application.

### Example 2

Retailer Benefits: One of the benefits for retailers choosing to implement this system is that they gain access to a larger and more substantial pool of marketing data as they can base their business decisions not just on sales figures, but also on an amount of interest shown in particular items. Because customers will tap (select) more items than they will actually buy, a greater amount of data will be generated. This will allow retailers to better arrange their products based on more accurate live indications of consumer preferences, as they will be able to test which configurations generate greater interest in particular items.

Integration with social networking platforms gives retailers access to additional information via access to users' general profile information such as what college users attended, occupation, age, friends list and country of residence. This gives the retailer a unique opportunity to learn more about their customers and their purchasing habits. The customer's purchase and interest history, also available to retailers, will allow retailers to send more targeted push notifications through the system that can specifically target customer interest customized to that customer.

An additional benefit to retailers is the ability to fight counterfeiting of their brands. With the placement of brand-specific NFC tags, fake merchandise is easily discernible from genuine merchandise with a simple scan.

What is claimed is:

1. A method for improving a user's retail shopping experience comprising:
selecting a plurality of merchandise items;
entering a plurality of merchandise item data into a merchandise database;
assigning an NFC ID to each of the plurality of merchandise items;
entering a plurality of merchandise related information into the merchandise database wherein the plurality of merchandise related information is associated with the plurality of merchandise items;
tagging the plurality of merchandise items with a plurality of NFC tags;
displaying the plurality of merchandise items in at least one retail location;
allowing a plurality of customers to snag at least one of the plurality of merchandise items that are displayed at the at least one retail location; and
providing a checkout service to allow the user to purchase the at least one of the plurality of merchandise items that are displayed at the at least one retail location.

2. The method of claim 1 further comprising sending at least one push notification to the user wherein the push notification contains merchandise related information.

3. The method of claim 1 further comprising the step of soliciting a user feedback response about at least one merchandise item and using the user feedback response to provide at least 1 product recommendation to the user.

4. The method of claim 1 further comprising curating a wish list of merchandise items the user wishes to purchase at a later time.

5. The method of claim 1 further comprising posting an image of a snagged merchandise item to a user's account on a social network website and soliciting members of the user's social network to provide feedback on the snagged merchandise item.

6. The method of claim 1 further comprising providing the retail location data about customer snags.

7. A method for providing customized product recommendations to a user comprising:
prompting a user to create an account with an NFC enabled retail shopping system;
allowing the user to visit a retail location, wherein the retail location has incorporated the NFC enabled retail shopping system;
allowing the user to snag an at least one merchandise item;
saving the at least one merchandise item snagged by the user to a snag history;
accessing a database containing a plurality of merchandise related information related to the at least one merchandise item snagged by the user;
providing the user with at least 1 product suggestion based off the plurality of merchandise related information related to the at least one merchandise item snagged by the user;
allowing the user to select the at least one product of the at least 1 product suggestion based off the plurality of merchandise related information related to the at least one merchandise item snagged by the user; and
providing a checkout interface to allow the user to purchase the at least one merchandise item snagged by the user, and/or the at least one selected product of the at least 1 product suggestion based off the plurality of merchandise related information related to the at least one merchandise item snagged by the user.

8. The method of claim 7 wherein the at least one product suggestion is sent to the user via a push notification.

9. The method of claim 7 further comprising adding merchandise items purchased through the checkout interface into an owned merchandise database.

10. The method of claim 7 further comprising prompting the user to input at least one merchandise item the user already owns into an owned merchandise database.

11. The method of claim 10 comprising providing at least one product recommendation based off a plurality of merchandise related information about the at least one merchandise item the user already owns.

12. A method for providing customized product recommendations to a user based on merchandise items a user already owns comprising:
generating a plurality of merchandise sets, wherein the merchandise sets comprise a plurality of individual merchandise items;
storing the plurality of merchandise sets in a merchandise set database;
accessing an owned merchandise database of the user;
identifying at least one individual merchandise item in the user's owned merchandise database;
identifying the plurality of merchandise sets that contain the at least one individual merchandise item in the user's owned merchandise database;
suggesting the plurality of merchandise sets that contain the at least one individual merchandise item in the user's owned merchandise database; and
providing the user with a way to purchase the plurality of merchandise sets that contain the at least one individual merchandise item in the user's owned merchandise database.

13. The method of claim 12 further comprising identifying individual merchandise items necessary to complete the merchandise set.

14. The method of claim 12 wherein the way to purchase the plurality of merchandise sets is a checkout interface.

15. The method of claim 12 wherein the way to purchase the plurality of merchandise sets comprises providing the user with a list of retail locations.
